(19) United States
(12) Patent Application Publication
(10) Pub. No.: US 2006/0152613 A1
(43) Pub. Date: Jul. 13, 2006

(54) Method and apparatus for displaying digital images

(75) Inventor: Won-jung Kim, Seongnam-si (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/120,290

(22) Filed: May 2, 2005

(30) Foreign Application Priority Data
Jan. 11, 2005 (KR) 10-2005-0002446

(51) Int. Cl. H04N 5/222

(52) U.S. Cl. 348/333.05

(57) ABSTRACT

Provided is a method of controlling a digital image processing apparatus that stores user files obtained as a result of a photographing operation in a photographing mode in a storage medium and reproduces the user files stored in the storage medium in a reproducing mode. In the method, the reproducing mode includes an index-reproducing mode in which a set number of index images are displayed in divided display regions in a sequence in which the index images are set. In addition, the index-reproducing mode includes an edited index-reproducing mode in which the index images are selectively displayed. The edited index-reproducing mode includes deleting loading data of an index image according to a user's choice and displaying the index images, excluding the index image whose loading data was deleted, in the divided display regions in the sequence in which the index images are set.

### BACKGROUND OF THE INVENTION

This application claims the priority of Korean Patent Application No. 10-2005-0002446, filed on Jan. 11, 2005, in the Korean Intellectual Property Office, the disclosure of which is incorporated herein in its entirety by reference.

1. Field of the Invention

The present invention relates to a method of controlling a digital image processing apparatus and a digital image processing apparatus adopting the method. More particularly, the present invention relates to a method of controlling a digital image processing apparatus that (1) stores user files obtained as a result of a photographing operation in a photographing mode in a storage medium and (2) reproduces the user files stored in the storage medium in a reproducing mode.

2. Description of the Related Art

A conventional digital photographing apparatus is disclosed in U.S. Patent Publication No. 119,876 entitled “Method of Notification of Inadequate Picture Quality”. When in a photographing mode, the conventional digital photographing apparatus stores user files obtained by a photographing operation in a storage medium. When in a reproducing mode, the conventional digital photographing apparatus reproduces the user files stored in the storage medium.

In addition, the conventional digital photographing apparatus can perform an index-reproducing mode in which a set number of index images are displayed in all divided display regions in the sequence the index images are set. However, since the index images are displayed regardless of a selection by a user, the user cannot select only desired index images and then arrange the selected index images in all of the divided regions.

### SUMMARY OF THE INVENTION

Various embodiments of the present invention provide a method of controlling a digital image processing apparatus, wherein the method enables a user to select desired index images and display the selected index images in all divided display regions of a display screen, and a digital image processing apparatus adopting the method.

According to an embodiment of the present invention, there is provided a method of controlling a digital image processing apparatus that stores user files obtained as a result of a photographing operation in a photographing mode in a storage medium and reproduces the user files stored in the storage medium in a reproducing mode.

The reproducing mode includes an index-reproducing mode in which a set number of index images are displayed in divided display regions in a sequence in which the index images are set. In addition, the index-reproducing mode includes an edited index-reproducing mode in which the index images are selectively displayed. The edited index-reproducing mode includes (a) deleting loading data of an index image according to a user's choice and (b) displaying the index images excluding the index image whose loading data was deleted in the divided display regions in the sequence in which the index images are set.

In the edited index-reproducing mode, a user may select undesired index images one by one and then display only the desired index images in divided display regions of a screen.

According to another embodiment of the present invention, there is provided a digital image processing apparatus adopting the controlling method.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view illustrating the front and the top of a digital camera according to the present invention;

FIG. 2 is a perspective view illustrating the back of the digital camera of FIG. 1;

FIG. 3 is a schematic diagram of the configuration of the digital camera of FIG. 1;

FIG. 4 is a flowchart illustrating a main program of a digital camera processor (DSP) illustrated in FIG. 3;

FIG. 5 is a flowchart illustrating an embodiment of the preview mode program of FIG. 4;

FIG. 6 is a flowchart illustrating an embodiment of the photographing mode program of FIG. 4;

FIG. 7 is a flowchart illustrating an embodiment of the reproducing mode program of FIG. 4;

FIG. 8 shows an example of a first screen displayed in a non-edited index-reproducing mode or an edited index-reproducing mode of FIG. 7;

FIG. 9 is a flowchart illustrating an embodiment of the non-edited index-reproducing mode program of FIG. 7;

FIG. 10 is a flowchart illustrating the edited index-reproducing mode program of FIG. 7;

FIG. 11 shows a screen obtained as a result of performing operations S114 and S116 of FIG. 10 when a second index image of FIG. 8 is deleted in operation S112 of FIG. 10 according to a user's choice;

FIG. 12 shows a screen obtained as a result of performing operations S114 and S116 of FIG. 10 when a fourth index image of FIG. 11 is deleted in operation S112 of FIG. 10 according to the user's choice; and

FIG. 13 shows a screen obtained as a result of performing operations S114 and S116 of FIG. 10 when a sixth index image of FIG. 12 is deleted in operation S112 of FIG. 10 according to the user's choice.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth therein; rather, these embodiments are provided so that this disclosure will be thorough and complete and will fully convey the concept of the invention to those skilled in the art.

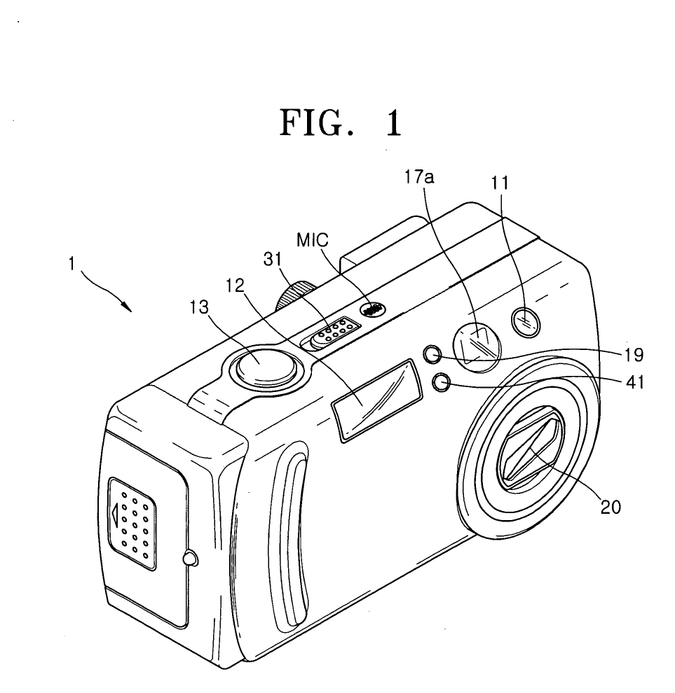

Referring to FIG. 1, the front part of a digital camera 1 according to the present invention includes a self-timer lamp 11, a flash 12, a viewfinder 17a, a flash-luminance sensor 19, a lens unit 20, and a remote receiver 41. The top of the digital camera 1 includes a shutter release button 13, a power switch 31, and a microphone MIC.

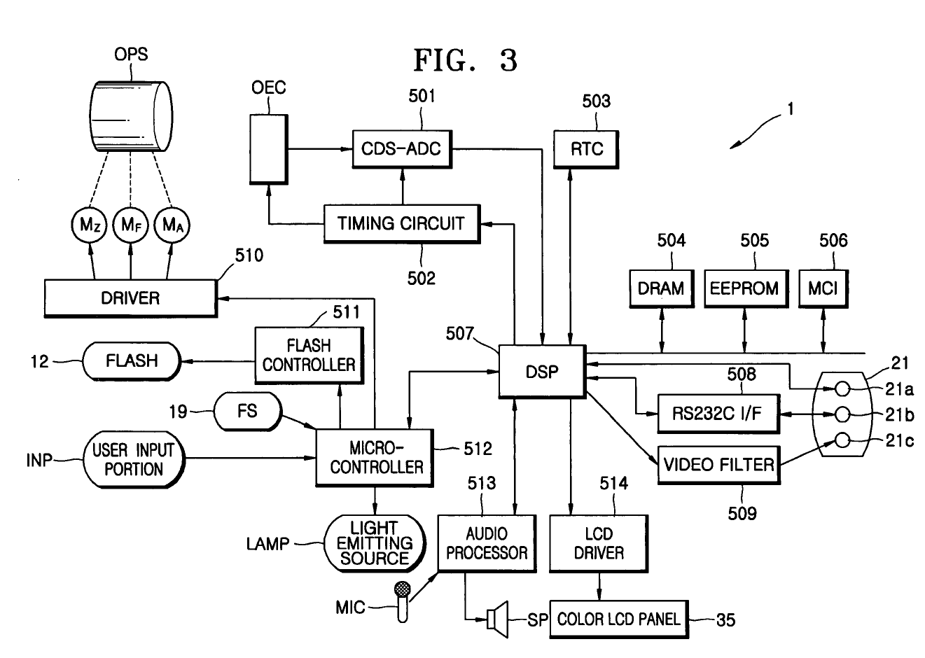

In a self-timer mode, the self-timer lamp 11 operates for a set period of time from the time when the shutter release button 13 is pressed to the time when an image starts to be captured. When the flash 12 operates, the flash-luminance sensor 19 senses luminance and relays the sensed luminance to a digital signal processor (DSP) 507 of FIG. 3 via a micro-controller 512 of FIG. 3. The remote receiver 41 receives command signals, for example, a photographing command signal, from a remote controller (not shown) and relays the command signals to the DSP 507 via the micro-controller 512.

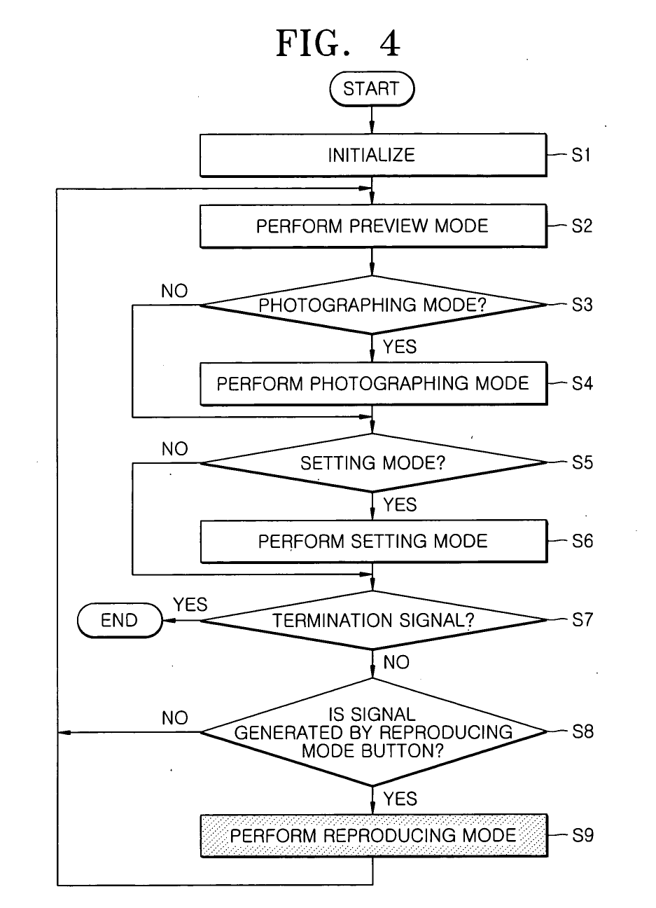

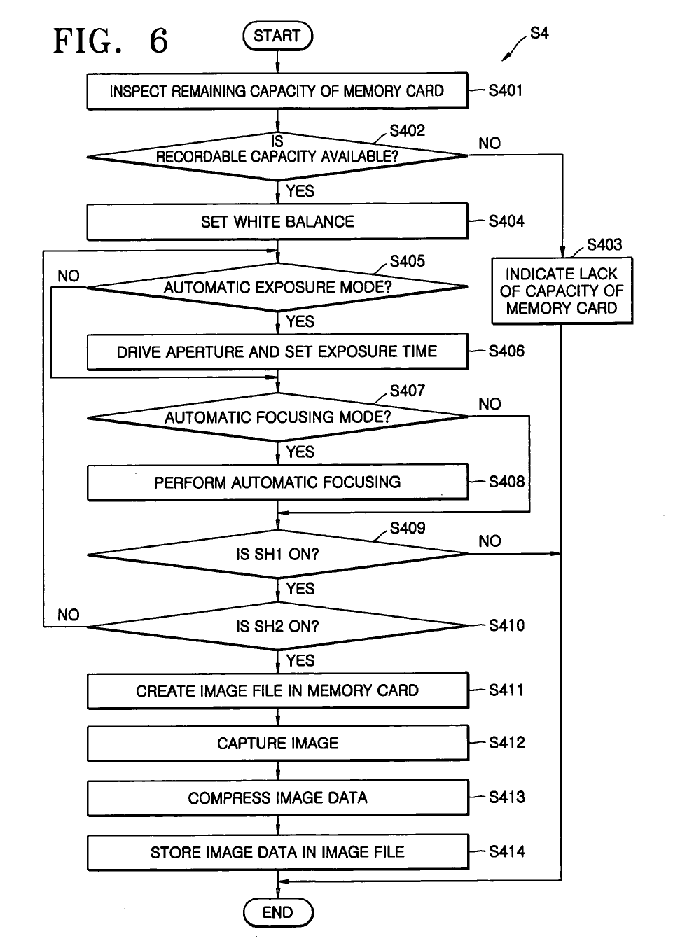

The shutter release button 13 has two levels. In other words, referring to FIGS. 4 and 6, when a user lightly depresses the shutter release button 13 to a first level, a first level signal SH1 from the shutter release button 13 is turned on. When the user fully depresses the shutter release button 13 to a second level, a second level signal SH2 from the shutter release button 13 is turned on.

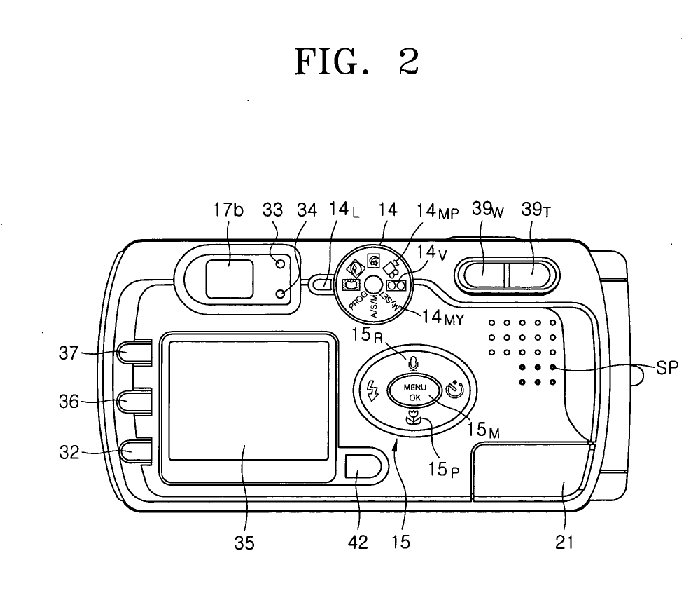

Referring to FIG. 2, the back of the digital camera 1 according to the present invention includes a mode dial 14, functional buttons 15, a manual focus/delete button 36, a manual adjust/reproduce/terminate button 37, a reproducing mode button 42, a speaker SP, a monitor button 32, an automatic focusing lamp 33, a viewfinder 17b, a flash standby lamp 34, a color LCD panel 35, a wide-angle zoom button 39_{W}, a telephoto zoom button 39_{T}, and an external interface unit 21.

The mode dial 14 is used for selecting the operating modes of the digital camera 1, such as a simple photographing mode, a program photographing mode, a character photographing mode, a night view photographing mode, a manual photographing mode, a moving-image photographing mode, a user-setting mode 14_{MY}, and an audio recording mode 14_{V}.

The user-setting mode 14_{MY} is an operating mode in which a user selects photograph-taking settings for each photographing mode. Reference numeral 14_{MP} indicates the moving-image photographing mode. The audio recording mode 14_{V} is for recording only sounds, for example, a user's voice. After selecting the audio recording mode 14_{V}, when a user presses the shutter release button 13, an audio file is created in the memory card, and audio data is stored in the audio file. When the user presses the shutter release button 13 again, the audio data stops being stored and the audio file is set.

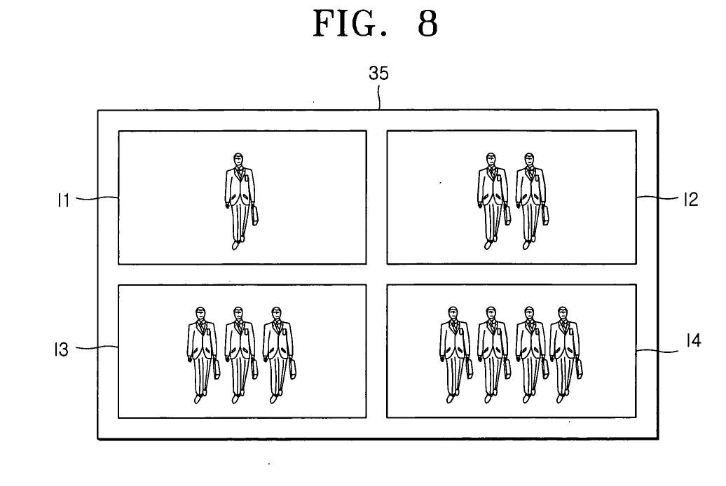

The wide-angle zoom button 39_{W} and the telephoto zoom button 39_{T} are used not only in the photographing mode but also in the reproducing mode. For example, when an image of a standard size is displayed in the reproducing mode, if the telephoto zoom button 39_{T} is pressed, the image is enlarged and then displayed. If the wide-angle zoom button 39_{W} is pressed, an index-reproducing mode is performed. In the index-reproducing mode, a set number of index images are displayed in divided display regions in the sequence in which the index images are set. The index-reproducing mode will be described later in detail with reference to FIGS. 8 through 13. In the index-reproducing mode, when the telephoto zoom button 39_{T} is pressed, a general display mode, in which an image currently activated is displayed in a standard size, is performed.

The functional buttons 15 are used for operating specific functions of the digital camera 1. The functional buttons 15 are also used as control buttons to manage the movement of an active cursor on the menu screen of the color LCD panel 35.

In a reproducing mode, when an image of the standard size is displayed, if the user presses a self-timer/right button 15_{R}, a next file in a forward direction is displayed. When an image currently displayed is enlarged in the reproducing mode, if the user presses the self-timer/right button 15_{R}, a display region of the enlarged image is moved to the right. In a preview mode, if the user presses the self-timer/right button 15_{R}, a self-timer operation, e.g., automatic photographing after 10 seconds, is performed.

In the reproducing mode, when an image of the standard size is displayed, if the user presses a flash/left button 15_{L}, a next file in a reverse direction is displayed. If the image currently displayed is enlarged, when the user presses the flash/left button 15_{L}, the display region of the enlarged image is moved to the left. In the preview mode, if the user presses the flash/left button 15_{L}, any one of the flash modes for a photographing mode is set.

In the reproducing mode, when the image currently displayed is enlarged, if the user presses a macro/down button 15_{D}, the display region of the enlarged image is moved down. In the preview mode, the user may set automatic proximity focusing by pressing the macro/down button 15_{D}.

In the reproducing mode, when the image currently displayed is enlarged, if the user presses a voice-memo/up button 15_{U}, the display region of the enlarged image is moved up. In the preview mode, if the user presses the voice-memo/up button 15_{U}, a 10 second recording is possible upon consecutive photographing.

In a setting mode from the preview mode, if the user presses a menu/select-confirm button 15_{M} when the active cursor is on a selection menu, an operation condition corresponding to the selection menu is set.

The manual adjust/reproduce/terminate button 37 is used for manual adjustment of specific conditions. In the reproducing mode, when the user presses the manual adjust/reproduce/terminate button 37, a selected moving-image file may be reproduced or its reproduction may be terminated.

The manual focus/delete button 36 is used for manual focusing or deleting in the photographing mode.

The monitor button 32 is used for controlling the operation of the color LCD panel 35. For example, in the photographing mode, when the user presses the monitor button 32, an image and photographing information are displayed on the color LCD panel 35. When the user presses the monitor button 32 again, the color LCD panel 35 is turned off. In the reproducing mode, when the user presses the monitor button 32 while an image file is being reproduced, photographing information about the image file is displayed on the color LCD panel 35. When the user presses the monitor button 32 again, only images are displayed.

The reproducing mode button 42 is used for switching between the reproducing mode and the preview mode.

The automatic focusing lamp 33 operates when a focus is well adjusted. The flash standby lamp 34 operates when the flash 12 of FIG. 1 is in a standby mode. A mode indicating lamp 14_{L} indicates a selection mode of the mode dial 14.

FIG. 3 is a schematic diagram of the configuration of the digital camera 1 of FIG. 1. The configuration and operation of the digital camera 1 of FIG. 1 will now be described with reference to FIGS. 1 through 3.

An optical system (OPS) including the lens unit 20 and a filter unit optically processes light from a subject. The lens unit 20 of the OPS includes a zoom lens, a focal lens, and a compensation lens.

When the user presses the wide-angle zoom button 39_{W} or the telephoto zoom button 39_{T} included in a user input portion (INP), a signal corresponding to the wide-angle zoom button 39_{W} or the telephoto zoom button 39_{T} is relayed to the micro-controller 512. The micro-controller 512 controls a driver 510, thereby running a zoom motor M_{Z}, which in turn, moves the zoom lens. In other words, when the user presses the wide-angle zoom button 39_{W}, the focus length of the zoom lens becomes short, thereby widening the angle of view. When the user presses the telephoto zoom button 39_{T}, the focus length of the zoom lens becomes long, thereby narrowing the angle of view. Since the position of the focus lens is adjusted in a state where the position of the zoom lens is set, the angle of view is hardly affected by the position of the focus lens.

In the automatic focusing mode, a main controller built into the DSP 507 controls the driver 510 through the micro-controller 512, thereby driving a focus motor M_{F}. Accordingly, when the focus lens is moved, the position of the focus lens, for example, a number of driving steps of the focus motor M_{F}, having a largest high frequency component of an image signal is set.

The compensation lens in the lens unit 20 of the OPS is not separately operated because the compensation lens compensates for the entire refractive index. Reference numeral M_{A} indicates a motor for driving an aperture (not shown).

An optical low pass filter included in the filter unit of the OPS eliminates high frequency optical noise. An infrared cut filter included in the filter unit of the OPS blocks the infrared component of incident light.

A photoelectric conversion unit (OEC) of a charge coupled device or a complementary metal oxide (CMOS) semiconductor converts light from the OPS into an analog electrical signal. Here, the DSP 507 controls a timing circuit 502 to control the operations of the OEC and a correlation-double-sampler-and-analog-to-digital converter (CDS-ADC) 501. The CDS-ADC 501 processes an analog signal from the OEC, eliminates high frequency noise, adjusts amplitude, and then converts the analog signal into a digital signal.

A real-time clock (RTC) 503 provides time information to the DSP 507. The DSP 507 processes the digital signal from the CDS-ADC 501 and generates a digital image composed of luminance and chromaticity values.

A light-emitting source (LAMP) is operated by the micro-controller 512 in response to a control signal generated by the DSP 507 including the main controller. The light-emitting source (LAMP) includes the self-timer lamp 11, the automatic focusing lamp 33, the mode indicating lamp 14_{L}, and the flash standby lamp 34. The user input portion INP includes the shutter release button 13, the mode dial 14, the functional buttons 15, the monitor button 32, the manual focus/delete button 36, the manual adjust/reproduce/terminate button 37, the wide-angle zoom button 39_{W}, the telephoto zoom button 39_{T}, and the reproducing mode button 42.

A dynamic random-access memory (DRAM) 504 temporarily stores a digital image signal from the DSP 507. An electrically erasable and programmable read only memory (EEPROM) 505 stores programs and setting data. A user's memory card is inserted or removed in a memory card interface (MCI) 506. The digital image signal from the DSP 507 is input to an LCD driver 514, thereby displaying an image on the color LCD panel 35.

The digital image signal from the DSP 507 can be transmitted as serial communications via a universal serial bus (USB) connector 21a or via an RS232C interface 508 and an RS232C connector 21b. The digital image signal from the DSP 507 can also be transmitted as a video signal via a video filter 509 and a video output unit 21c.

An audio processor 513 can relay sound from the microphone MIC to the DSP 507 or to the speaker SP. In addition, the audio processor 513 can output an audio signal from the DSP 507 to the speaker SP. The micro-controller 512 controls the operation of a flash controller 511 in response to a signal from the flash-luminance sensor 19, thereby driving the flash 12.

A main program of the DSP 507 of FIG. 3 will be now described with reference to FIGS. 1 through 4.

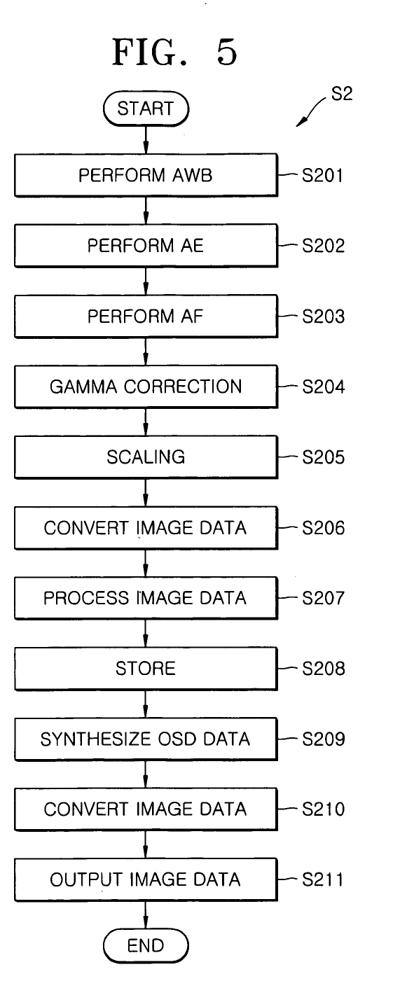

When power is applied to the digital camera 1, the DSP 507 is initialized (S1). After the initialization (S1), the DSP 507 performs a preview mode (S2). In the preview mode, an input image is displayed on the color LCD panel 35. An operation related to the preview mode will be described in detail later with reference to FIG. 5.

When the user lightly depresses the shutter release button 13 to the first level and the first level signal SH1 from the shutter release button 13 is turned on (S3), the DSP 507 performs a current photographing mode (S4). The photographing mode (S4) program will be described in detail later with reference to FIG. 6.

When INP generated signals corresponding to a setting mode are input (S5), the setting mode for setting an operating condition in response to the input signals from the INP is performed (S6). When a termination signal is not generated, the DSP 507 continues to perform the following operations (S7).

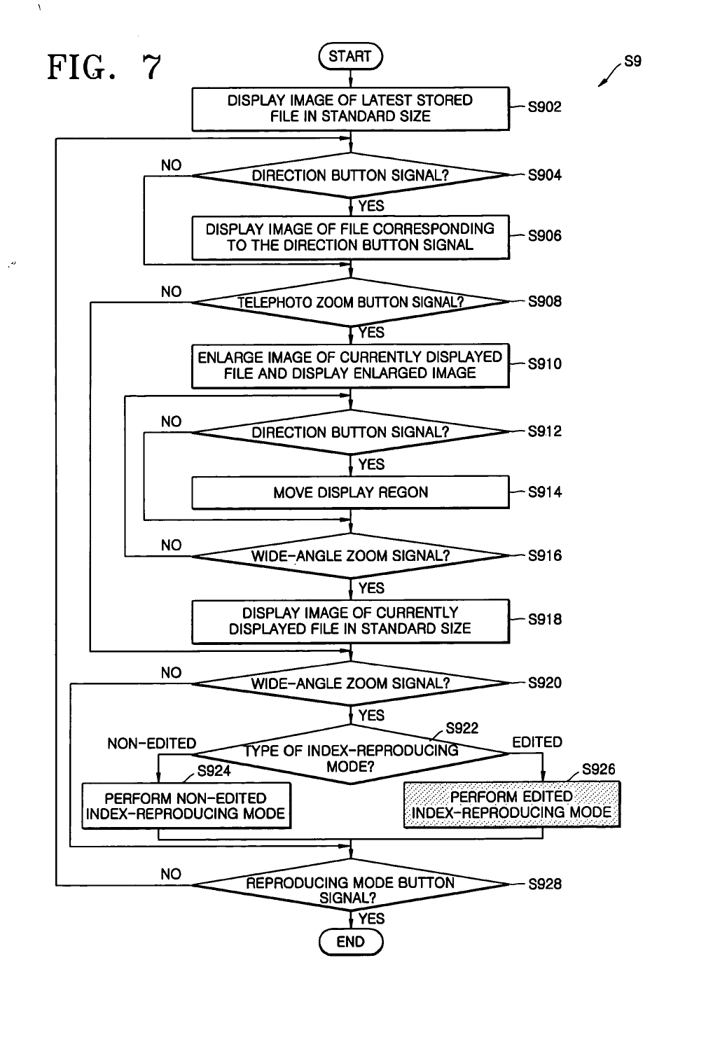

When a signal is generated by the reproducing mode button 42 in the user input portion INP (S8), the reproducing mode is performed (S9). In the reproducing mode, the DSP 507 performs a reproduction operation in response to the input signals from the user input portion INP. The reproducing mode program (S9) will be described later with reference to FIGS. 7 through 13. When the reproducing mode is terminated, the above operations are repeated.

An embodiment of the preview mode (S2) program will now be described with reference to FIGS. 1 through 3 and FIG. 5.

The DSP 507 performs automatic white balancing (AWB) and sets parameters related to the white balance (S201). The DSP 507 performs automatic exposure (S202). The DSP 507 calculates the exposure by measuring incident luminance, drives the aperture driving motor MA according to the calculated exposure, and sets exposure time. Then, the DSP 507 performs automatic focusing (S203).

The DSP 507 performs gamma correction on input image data (S204) and scales the gamma corrected image data to meet display standards (S205). The DSP 507 converts the scaled input image data from an RGB (red, green, and blue) format into a luminance-chromaticity format (S206). The DSP 507 processes the input image data depending on resolution and where the input image data is displayed and filters the input image data (S207).

The DSP 507 temporarily stores the input image data in the DRAM 504 of FIG. 3 (S208). The DSP 507 synthesizes the data temporarily stored in the DRAM 504 of FIG. 3 and on-screen display (OSD) data (S209). The DSP 507 converts the synthesized image data from the RGB format into the luminance-chromaticity format (S210) and outputs the image data in the converted format via the LCD driver 514 of FIG. 3(S211).

FIG. 6 is a flowchart illustrating an embodiment of the photographing mode (S4) program of FIG. 4. The photographing mode (S4) program of FIG. 4 will now be described with reference to FIGS. 1 through 3 and 6. Here, the current position of the zoom lens is already set.

The DSP 507 inspects the remaining capacity of the memory card (S401) and determines whether the memory card has enough capacity to store a digital image signal (S402). If the memory card does not have enough storage capacity, the DSP 507 indicates the lack of capacity of the memory card and ends the photographing mode (S403). If the memory card has enough storage capacity, the following operations are performed.

The DSP 507 sets white balance and parameters related to the white balance according to a present photographing condition (S404). In the automatic exposure mode (S405), the DSP 507 calculates the exposure by measuring incident luminance, drives the aperture driving motor MA according to the calculated exposure, and sets exposure time (S406). In the automatic focusing mode (S407), the DSP 507 performs automatic focusing and drives the focal lens (S408).

When the first level signal SH1 from the shutter release button 13 is on (S409), the DSP 507 performs the following operations.

The DSP 507 identifies whether the second level signal SH2 is on (S410). When the second level signal SH2 is not on, it means that the user did not press the shutter release button 13 to the second level to take a photograph. Then, the DSP 507 repeats S405 through S410.

When the second level signal SH2 is on, it means that the user fully depressed the shutter release button 13 to the second level. Then, the DSP 507 creates an image file in the memory card (S411). Next, the DSP 507 captures an image (S412). In other words, the DSP 507 receives still-image data from the CDS-ADC 501. Then, the DSP 507 compresses the received still-image data (S413). The DSP 507 stores the compressed still-image data in the image file (S414).

An embodiment of the reproducing mode (S9) program of FIG. 4 will now be described with reference to FIGS. 1 through 3 and 7. The DSP 507 controls the LCD driver 514 to display an image of a latest file stored in the memory card in a standard size on the color LCD panel 35 (S902). Here, the standard size denotes the size of an image displayed in all display regions of the color LCD panel 35.

If the user generates a direction signal by pressing the self-timer/right button 15_{R}, the flash/left button 15_{L}, the macro/down button 15_{D}, and/or the voice-memo/up button 15_{U} (S904), the DSP 507 controls the LCD driver 514 to display an image of a file corresponding to the direction signal in the standard size on the color LCD panel 35 (S906).

If the user generates a telephoto zoom button signal by pressing the telephoto zoom button 39_{T} (S908), the DSP 507 controls the LCD driver 514 to enlarge the image of the file currently displayed and display the enlarged image on the color LCD panel 35 (S910).

When the image is enlarged, if the user generates the direction signal by pressing the self-timer/right button 15_{R}, the flash/left button 15_{L}, the macro/down button 15_{D}, and/or the voice-memo/up button 15_{U} (S912), the DSP 507 controls the LCD driver 514 to move a display region of the enlarged image in response to the direction signal (S914).

When the image is enlarged, if the user generates a wide-angle zoom button signal by pressing the wide-angle zoom button 39_{W} (S916), the DSP 507 controls the LCD driver 514 to display the image of the file currently displayed in the standard size on the color LCD panel 35 (S918).

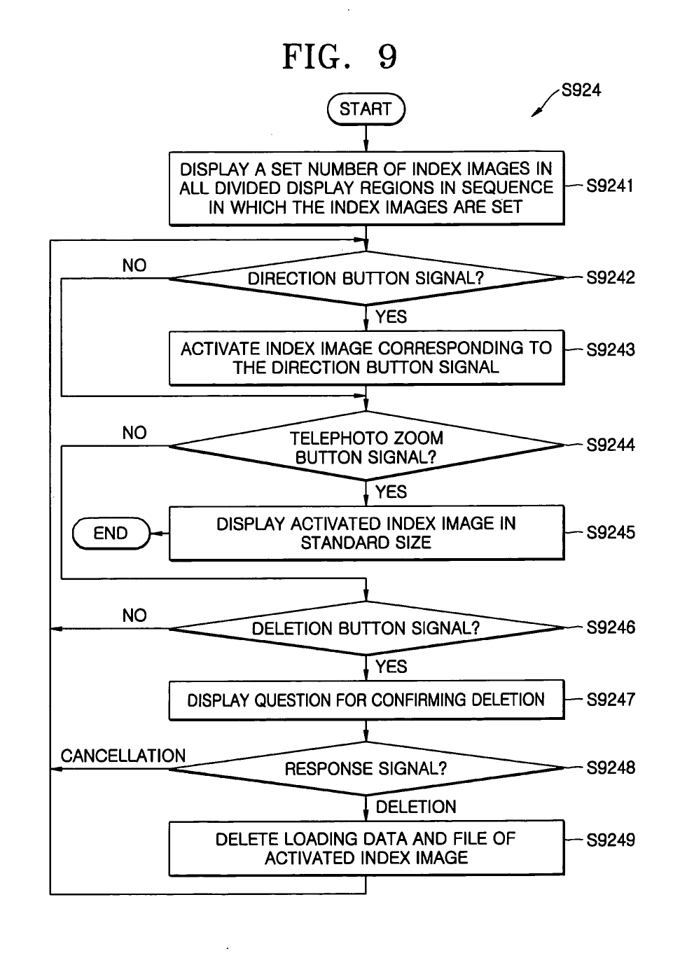

When the image is displayed in the standard size, if the user generates the wide-angle zoom button signal (S920), the DSP 507 performs the index-reproducing mode. In the index-reproducing mode, a set number, for example, four, of index images are displayed in divided display regions in the sequence in which the index images are set. In this case, the DSP 507 performs a non-edited index-reproducing mode or an edited index-reproducing mode (S922 through S926). The non-edited index-reproducing mode (S924) will be described in detail later with reference to FIGS. 8 and 9. Also, the edited index-reproducing mode (S926) will be described in detail later with reference to FIGS. 8 and 10 through 13. Operations S904 through 926 are repeated until the user presses the reproducing mode button 42 (S928).

FIG. 8 shows an example of a first screen displayed in the non-edited index-reproducing mode (S924) or the edited index-reproducing mode (S926) of FIG. 7. Referring to FIGS. 7 and 8, a first index image I1, which is an index image of the image displayed in the standard size in operation S918 of FIG. 7, is displayed in the upper left of a screen of the color LCD panel 35 of FIGS. 2 and 3. A second index image I2, which comes after the first index image I1, is displayed in the upper right of the screen of the color LCD panel 35. A third index image I3, which comes after the second index image I2, is displayed in the lower left of the screen of the color LCD panel 35. A fourth index image I4, which comes after the third index image I3, is displayed in the lower right of the screen of the color LCD panel 35.

FIG. 9 is a flowchart illustrating an embodiment of the non-edited index-reproducing mode (S924) program of FIG. 7. The non-edited index-reproducing mode (S924) program of FIG. 7 will now be described with reference to FIGS. 1 through 3, 8 and 9.

The DSP 507 controls the LCD driver 514 to display a set number, for example, four, of index images (the first through fourth index images I1 through I4) in all divided display regions in the sequence in which the four index images are set (S9241, see FIG. 8).

When the user selects an index image by pressing the self-timer/right button 15_{R}, the flash/left button 15_{L}, the macro/down button 15_{D}, and/or the voice-memo/up button 15_{U} (S9242), the DSP 507 controls the LCD driver 514 to activate the index image corresponding to a direction button signal (S9243).

When one of the index images is activated as described above, if the user generates the telephoto zoom button signal by pressing the telephoto zoom button 39_{T} (S9244), the DSP 507 controls the LCD driver 514 to enlarge the index image currently activated to have the standard size and display the enlarged index image (S9245) and terminates the non-edited index-reproducing mode (S924).

When an index image is activated as a result of performing operations S9242 and S9243, if the user generates a signal by pressing the manual focus/delete button 36 (S9246), the DSP 507 controls the LCD driver 514 to display a question for confirming file deletion on the color LCD panel 35 (S9247). If a response signal generated by the user indicates cancellation, operation S9242 and its subsequent operations are repeated (S9248). If the response signal generated by the user indicates approval of file deletion, the DSP 507 deletes loading data and a file of the activated index image and repeats operation S9242 and its subsequent operations (S9248 and S9249). Here, the loading data denotes frame data stored in the DRAM 504. In addition, the file denotes a file stored in the memory card through the memory card interface 506.

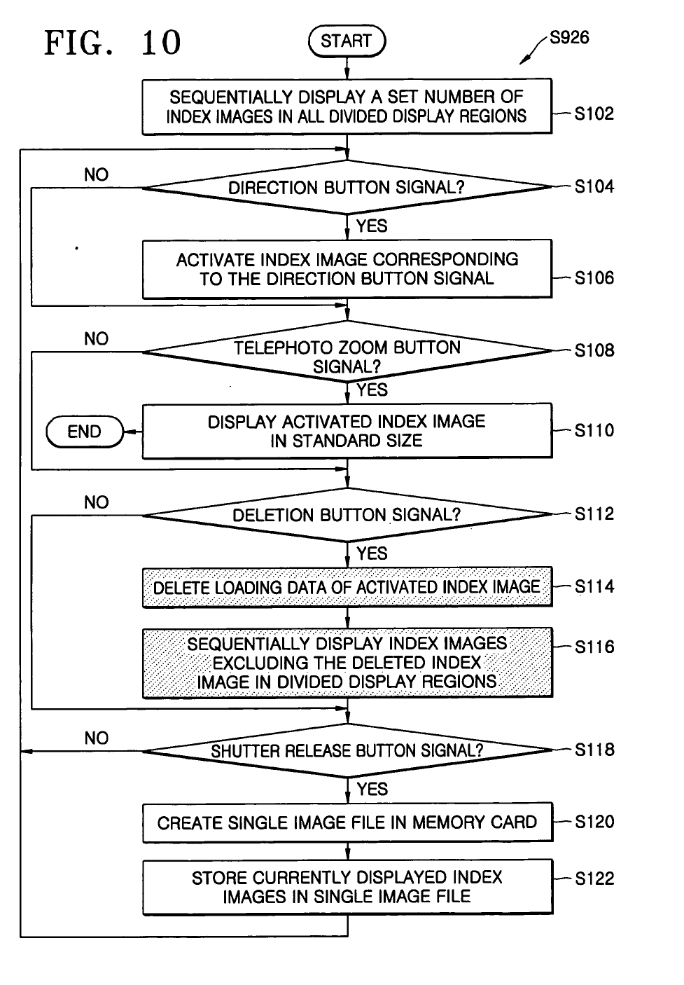

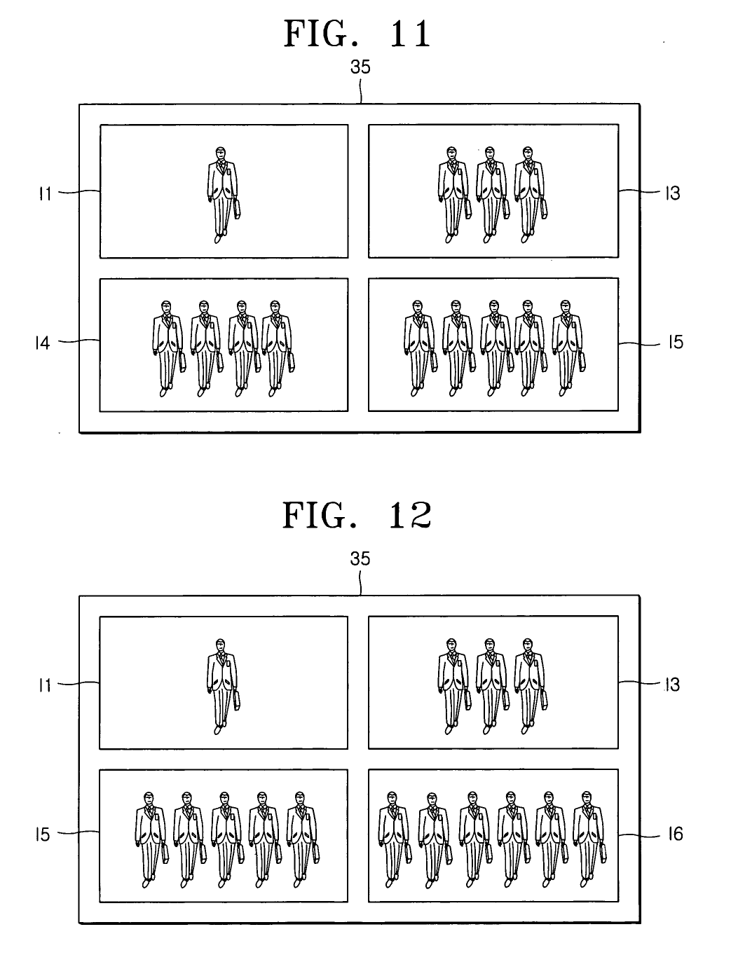

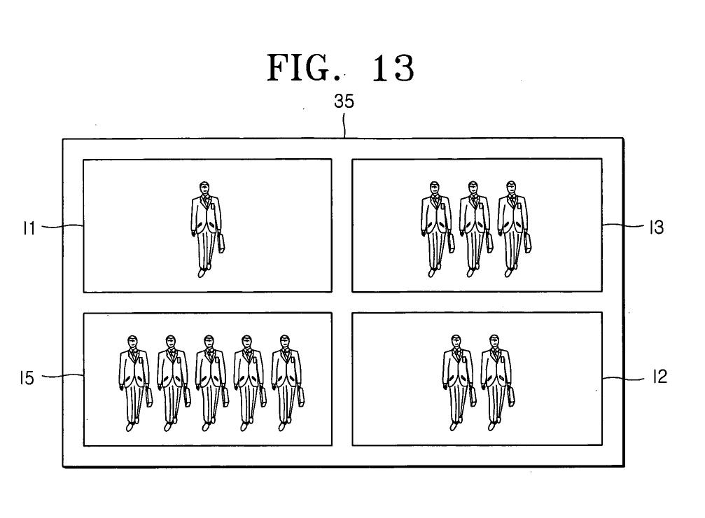

FIG. 10 is a flowchart illustrating the edited index-reproducing mode (S926) program of FIG. 7. FIG. 11 shows a screen obtained as a result of performing operations S114 and S116 of FIG. 10 when the second index image I2 of FIG. 8 is deleted in operation S112 of FIG. 10 according to a user's choice. FIG. 12 shows a screen obtained as a result of performing operations S114 and S116 of FIG. 10 when the fourth index image I4 of FIG. 11 is deleted in operation S112 of FIG. 10 according to the user's choice. FIG. 13 shows a screen obtained as a result of performing operations S114 and S116 of FIG. 10 when the sixth index image I6 of FIG. 12 is deleted in operation S112 of FIG. 10 according to the user's choice.

An embodiment of the edited index-reproducing mode (S926) of FIG. 7 will now be described with reference to FIGS. 8 and 10 through 13. The DSP 507 controls the LCD driver 514 to display a set number, for example, four, of index images (the first through fourth index images I1 through I4) in divided display regions in the sequence in which the four index images are set, as shown in FIG. 8. (S102).

When the user selects an index image by pressing the self-timer/right button 15_{R}, the flash/left button 15_{L}, the macro/down button 15_{D}, and/or the voice-memo/up button 15_{U} (S104), the DSP 507 controls the LCD driver 514 to activate the index image corresponding to a direction button signal (S106).

When one of the index images is activated as described above, if the user generates the telephoto zoom button signal by pressing the telephoto zoom button 39_{T} (S108), the DSP 507 controls the LCD driver 514 to enlarge the index image currently activated to the standard size and display the enlarged index image (S110) and terminates the edited index-reproducing mode (S926).

When an index image is activated as a result of performing operations S104 and S106, if the user generates a signal by pressing the manual focus/delete button 36 (S112), the DSP 507 deletes loading data of the activated index image (S114). As described above, the loading data denotes frame data stored in the DRAM 504. In addition, the DSP 507 displays index images excluding the deleted index image in divided display regions of the color LCD panel 35 in the order in which the index images are stored (S116, see FIGS. 8 and 11 through 13). Therefore, referring to FIGS. 8 and 11 through 13, the user can select undesired index images one by one and arrange only desired index images in divided regions of the color LCD panel 35.

If the user did not press the shutter release button 13, operation S104 and its subsequent operations are repeated (S118).

When the user generates a signal by pressing the shutter release button 13, the DSP 507 creates a new single image file in the memory card (S118 and S120). In addition, the DSP 507 stores the currently displayed index images in the single image file (S122). Accordingly, the user can easily print desired index images with simple manipulations. Then, operation S104 and its subsequent operations are repeated.

Referring to FIG. 11, when the second index image I2 of FIG. 8 is deleted in operation S112 of FIG. 10 according to the user's choice, the third index image I3 is displayed in the divided display region which previously contained the second index image I2. Since the third index image I3 has moved to the divided display region of the second index image I2, the fourth index image I4 is displayed in the lower left of the display region and the fifth index image I5 is displayed in the lower right of the display region.

Referring to FIG. 12, when the fourth index image I4 of FIG. 11 is deleted in operation S112 of FIG. 10 according to the user's choice, the fifth index image I5 is displayed in the divided display region which previously contained the fourth index image I4. Since the fifth index image I5 has moved to the divided display region which previously contained the fourth index image I4, a sixth index image I6 is displayed in the lower right of the display region.

Referring to FIG. 13, when the sixth index image I6 of FIG. 11 is deleted in operation S112 of FIG. 10 according to the user's choice, the second index image I2 is displayed in the divided display region which previously contained the sixth index image I6. Here, it is assumed that 6 image files are stored in the memory card.

Therefore, referring to FIGS. 8 and 11 through 13, the user can select undesired index images one by one and arrange only desired index images in divided regions of the color LCD panel 35.

As described above, according to a method of controlling a digital image processing apparatus and a digital image processing apparatus adopting the method according to the present invention, in an edited index-reproducing mode, a user can select undesired index images one by one and arrange only desired index images in divided regions of a display screen.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method for displaying images, the method comprising:
storing a first image file in a storage medium;
displaying, on a display screen, a first thumbnail image that represents the first image file;
detecting a selection signal;
in response to detecting the selection signal, selecting the first thumbnail image;
detecting a deletion signal; and
in response to detecting the deletion signal, ceasing to display the selected thumbnail image on the display screen without deleting its corresponding first image file.

2. The method of claim 1, further comprising:
storing loading information for the thumbnail image; and
in response to detecting the deletion signal, deleting the loading information.

3. The method of claim 2, wherein the loading information is stored in a random-access memory.

4. The method of claim 1, further comprising:
displaying a first plurality of thumbnail images including the selected thumbnail image, wherein each member of the first plurality is displayed on a portion of the display screen which is distinct from display areas for remaining members of the first plurality; and
continuing to display non-selected thumbnail images after ceasing to display the selected thumbnail image.

5. The method of claim 4, wherein the first plurality of thumbnail images is a subset of a second plurality of images, further comprising:
displaying a replacement thumbnail image, wherein the replacement thumbnail image is a member of the second plurality of thumbnail images but is not a member of the first plurality of thumbnail images.

6. The method of claim 4, wherein the thumbnail images of the first plurality are displayed in a storage order.

7. The method of claim 4, wherein a display position of at least one non-selected thumbnail image is altered after the selected thumbnail image is no longer displayed.

8. The method of claim 4, further comprising storing an index image that represents thumbnail images currently being displayed on the display screen.

9. An image display apparatus, the apparatus comprising:
a display screen;
a storage medium; and
a digital processor, wherein the digital processor performs steps comprising:
controlling the apparatus to display a first thumbnail image on the display screen;
detecting a user input; and
in response to the user input, controlling the apparatus to remove the first thumbnail image from the display screen and preserving, within the storage medium, a main image file that corresponds to the thumbnail image.

10. The apparatus of claim 9, further comprising:
a lens unit that receives light from a subject to be photographed by the apparatus; and
a photoelectric device that converts the received light to electrical signals, wherein the digital processor generates the first thumbnail image and the main image file based at least in part on the signals.

11. The apparatus of claim 9, wherein the digital processor further controls the apparatus to display a replacement thumbnail image after removing the first thumbnail image from the display screen.

12. The apparatus of claim 9, wherein the digital processor performs further steps comprising:
storing loading information for the first thumbnail image; and
deleting loading information for the activated first thumbnail image.

13. The apparatus of claim 9, further comprising a random-access memory for storing loading data of the first thumbnail image.

14. The apparatus of claim 9, wherein the steps performed by the digital processor of claim 9 are in response to detecting an edited-index mode signal.

15. The apparatus of claim 9, wherein;
the digital processor controls the apparatus to concurrently display a plurality of thumbnail images including the first thumbnail image; and
each member of the plurality of thumbnail images is displayed on a portion of the display screen which is distinct from display areas for other members of the plurality of thumbnail images.

16. The apparatus of claim 15, further comprising the digital processor controlling the apparatus to store an index image which represents the plurality of displayed thumbnail images.

17. A method of operating an image display apparatus comprising a display screen, a storage medium, and a digital processor, the method comprising:
displaying a plurality of thumbnail images on the display screen concurrently, wherein each thumbnail image has a separate display area;
detecting an activation signal;
in response to detecting an activation signal, the digital processor activating a thumbnail image;
detecting a deletion signal;
in response to detecting a deletion signal, the digital processor removing the activated thumbnail image from the display screen while maintaining a corresponding main image file in the storage medium; and
the digital processor continuing to display the rest of the plurality of thumbnail images on the display screen.

18. The method of claim 17, further comprising:
storing loading information for the plurality of thumbnail images; and
in response to detecting a deletion signal, deleting loading information which corresponds to the activated thumbnail image.

19. The method of claim 17, further comprising:
displaying a replacement image on the display screen.

20. The method of claim 17, wherein the steps of the method are performed in response to detecting an edited-index display mode signal.
